(19) United States
(12) Patent Application Publication
(10) Pub. No.: US 2014/0081761 A1
(43) Pub. Date: Mar. 20, 2014

(54) METHOD AND SYSTEM FOR REAL-TIME SOCIAL GIFTING

(71) Applicants: Jayaram Singonahalli, Belmont, CA (US); Mack Cage, Redwood City, CA (US); David M. Kalman, San Mateo, CA (US); Jeffrey Michael Cooper, San Jose, CA (US)

(72) Inventors: Jayaram Singonahalli, Belmont, CA (US); Mack Cage, Redwood City, CA (US); David M. Kalman, San Mateo, CA (US); Jeffrey Michael Cooper, San Jose, CA (US)

(21) Appl. No.: 13/623,580

(22) Filed: Sep. 20, 2012

(51) Int. Cl. G06Q 30/02; G06Q 30/06

(52) U.S. Cl. 705/14.58; 705/26.1

(57) ABSTRACT

Disclosed are methods and systems for sending targeted and contextual promotional offers on behalf of a merchant by receiving location information for a particular venue by a storage/processing module, gathering contextual information, mapping merchant requirements to the location information, and sending the promotional offers to users, the contextual information provided by portable communication devices, and the mapping based on a predefined criteria and a subset of users whose requirements are mapped on the predefined criteria.

### FIELD OF INVENTION

The present invention relates to social gifting and specifically relates to a method and system for real-time social gifting.

### BACKGROUND OF THE INVENTION

Advancements in Internet-based communication technology have enabled users to interact with each other. More often than not, these users access the Internet using their mobile phones to chat, purchase gifts online and arrange for the delivery of the gifts to friends and family.

With the advent of social networking sites, users have started purchasing gifts over the Internet based on the individual preferences of their family and friends and their assumed location in a specific time frame. For example, a user may like to send a gift of a team t-shirt to his friend who is planning to attend a baseball game in a particular stadium. The user may send the gift to his friend based on his friend's posts, messages, and stated preferences on the social networking sites. The posts, messages, and preferences may be counted as contextual information.

In addition, merchants can send promotional offers to users who might be interested in their products. These merchants may use the posts, messages, and known preferences of users on social networking sites to target promotional offers to some subset of users.

In the scenarios above, an assumption of the location of the users and the contextual information associated with the users is made. In some cases, these assumptions may prove to be wrong. For example, the user who has posted on the social networking site that he is planning to attend a baseball game may not turn up in the stadium. In this case, a friend may waste his money and effort to present him with a contextual gift, or lacking the user's correct location and context, a friend may be unable to send any relevant gift at all.

Similarly, the assumption of the contextual behavior information and the location information made by the merchant may prove to be wrong. The merchant may end up sending promotional offers to users who might not be interested in his offers, or lacking users' correct locations and context the merchant may be unable to present any relevant promotional offer at all. Moreover, the gathering of contextual information from social networking sites for each user on a real-time basis and making an approximation of the users' location and behavior is a tedious and time-consuming task, and in some cases, is not even possible due to the limitations and policies of the social network sites.

To overcome the above-stated problems, there are known approaches for providing targeted promotional offers as well as for targeted gifting. One widely-used approach is location-based targeted advertisement which has been disclosed in published patent applications.

In particular, U.S. Patent Application number 2009/0125396 is directed to a computer-based method for generating and transmitting a location-based offer reminder. The invention includes an interface element for at least one specially programmed general-purpose computer; a memory element for the at least one specially programmed general-purpose computer, and a reminder element, in a processor for at least one specially programmed general-purpose computer. The memory element stores a record of at least one communication sent to at least one wireless communications device (WCD). The reminder element is for: identifying the at least one WCD as being within a prescribed geographical area using the interface element, determining that a response to at least one communication has not been received, generating at least one reminder regarding at least one communication, and transmitting at least one reminder to a wireless communications network for transmission to the at least one WCD using the interface element.

In another instance, U.S. Patent Application number 2009/0125380 is directed to a method and system for providing a location-based offer. The invention includes: an interface element for at least one specially programmed general-purpose computer, a memory unit for at least one specially programmed general-purpose computer, and an offer element, in a processor for at least one specially programmed general-purpose computer. The offer element is for: generating at least one respective offer for at least one item or service from at least one business entity using the processor and at least one of a first set of rules or a first artificial intelligence program stored in the memory unit, the offer for display on a map showing respective locations for the at least one first business entity; transmitting at least one respective offer to a wireless communications network for transmission to a wireless communications device (WCD) for display on a map by the WCD, using the interface element and according to at least one of a second set of rules or a second artificial intelligence program stored in the memory unit, and receiving a selection of an offer from among at least one respective offer from the WCD via the wireless communications network and using the interface element.

In yet another instance, U.S. Patent Application number 2004/0215516 is directed to a method of providing a user with information about a product or service, via machine-readable coded data disposed on or in a surface of an article. The method comprises the steps of receiving interaction data representing interaction of a sensing device with the coded data, receiving location data indicative of a geographical location, determining the information and providing the information to the user from the location data and the interaction data. The interaction data is generated at least partially on the basis of at least some of the coded data being sensed by the sensing device as the interaction took place.

In the above cited patent applications, the real-time contextual information of the user is not a prominent factor while making targeted promotional offers. Although this combination of approaches for making assumptions based on the location and contextual information with the available social networking sites and location-based targeted promotional offers are available, it remains cumbersome and requires a strong approximation and statistical system to accommodate all the possible forms of contextual information and location information.

In light of the above discussion, there is a need for methods and systems that should enable a merchant to make a targeted promotional offer based on the real-time contextual information and location information. In addition, the system and method should enable users to purchase gifts based on the real-time contextual and location information of their family and friends.

### BRIEF SUMMARY OF THE INVENTION

The present invention provides a method for sending targeted and contextual promotional offers on behalf of a merchant in accordance with various embodiments of the present invention. The method includes receiving location information from one or more users for a particular venue by a storage/processing module, gathering contextual information of each of the one or more users by the storage/processing module, mapping requirements of the merchant with the received location information and contextual information, and sending the promotional offers to a subset of one or more users. The contextual information is provided by each user by a corresponding portable communication device and mapping is performed based on a predefined criteria. The subset of one or more users corresponds to users whose requirements are mapped on the predefined criteria.

In embodiments of the present invention, each of the one or more users activates a permission session for tracking their location. The location of the user is tracked on a real-time basis after activating the permission session.

In embodiments of the present invention, the contextual information is gathered from one or more social networking services. In embodiments of the present invention, the contextual information is provided by the user. In embodiments of the present invention, the storage/processing module requests the contextual information from the user. In embodiments of the present invention, the predefined criteria are based on the contextual and location information.

In embodiments of the present invention, the method for enabling a purchase of the gift is provided. The method includes receiving contextual data of a first user by a second user via a storage/processing module, gathering location information of the first user by the second user through the storage/processing module, purchasing a gift from a merchant by the second user for the first user based on a predefined criteria and informing the first user and the merchant confirming the purchase via the storage/processing module. The first user is associated with a first portable communication device and a second user is associated with a second portable communication device. The first user activates a permission session in the first portable communication device and the first user allows the second user to view the first user's location through the storage/processing module. The first user allows the second user to view the contextual information through the storage/processing module.

In embodiments of the present invention, the location of the first user is tracked on a real-time basis after activating the permission session. The first user deactivates the permission session on receiving the promotional offers or on leaving the venue.

In embodiments of the present invention, the contextual information is gathered from social networking services. In embodiments of the present invention, the contextual information is provided by the user.

In embodiments of the present invention, the method further includes the step of collecting the gift by the first user on receiving the confirmation of purchase. In embodiments of the present invention, the predefined criterion is based on the contextual and location information.

In embodiments of the present invention, a system for sending targeted and contextual promotional offers on behalf of a merchant is provided. The system includes an information gathering module operative to receive location information from at least one user at a particular venue, and collect the contextual information of each user. The system further includes a mapping module to map the requirements of the merchant with the received location information and contextual information, and a transmitting module to send the promotional offers to a subset of at least one user. The contextual information is provided by each user by a portable communication device and a contextual information database stores the contextual information. Each of the at least one user acknowledges tracking the location for the particular venue and a location-tracking database stores the location information. The mapping is done based on a predefined criteria and the subset of at least one user corresponds to users whose requirements are mapped on the predefined criteria.

In embodiments of the present invention, the contextual information is collected from social networking services. In embodiments of the present invention, the contextual information is provided by the user. In embodiments of the present invention, the information gathering module requests the contextual information from the user.

### BRIEF DESCRIPTION OF FIGURES

The features of the present invention, which are believed to be novel, are set forth with particularity in the appended claims. The invention may best be understood by reference to the following description, taken in conjunction with the accompanying drawings, wherein:

FIG. 1 is a schematic view of an illustrative portable communication device for providing an application operative to interface with a social gifting system in accordance with some embodiments of the invention;

FIG. 2 illustrates a flow chart for sending targeted and contextual promotional offers on behalf of a merchant, in accordance with some embodiments of the present invention;

FIG. 3 illustrates a flow chart for purchasing a gift for a user, in accordance with various embodiments of the present invention;

FIG. 4 illustrates the social gifting system for sending targeted and contextual promotional offers on behalf of a merchant, in accordance with various embodiments of the present invention;

FIG. 5 illustrates the social gifting system for purchasing a gift for a user, in accordance with various embodiments of the present invention;

FIGS. 6A-6K illustrate snapshots of the user interface of the application operative to interface with the social gifting system, in accordance with various embodiments of the present invention;

FIGS. 7A-7P illustrate snapshots of the user interface of the application operative to interface with the social gifting system which the user will view while sending the gift, in accordance with various embodiments of the present invention;

FIGS. 8A-8F illustrate snapshots of the user interface of the application operative to interface with the social gifting system which the user will view while redeeming the gift, in accordance with various embodiments of the present invention;

FIGS. 9A-9D illustrate a snapshot of the user interface application operative to interface with the social gifting system which the user will view while upgrading seats in a sports stadium, in accordance with various embodiments of the present invention; and

FIG. 10 illustrates a snapshot of the user interface application operative to interface with the social gifting system that the user will view to enable or disable permission for detection of his location while interacting with a mobile phone application.

Those with ordinary skill in the art will appreciate that the elements in the Figures are illustrated for simplicity and clarity and are not necessarily drawn to scale. For example, the dimensions of some of the elements in the figures may be exaggerated, relative to other elements, in order to improve the understanding of the present invention.

### DETAILED DESCRIPTION OF THE INVENTION

Before describing in detail the particular method and system for real-time social gifting, in accordance with various embodiments of the present invention, it should be observed that the present invention resides primarily in combinations of method steps related to real-time social gifting. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having” as used herein, are defined as comprising.

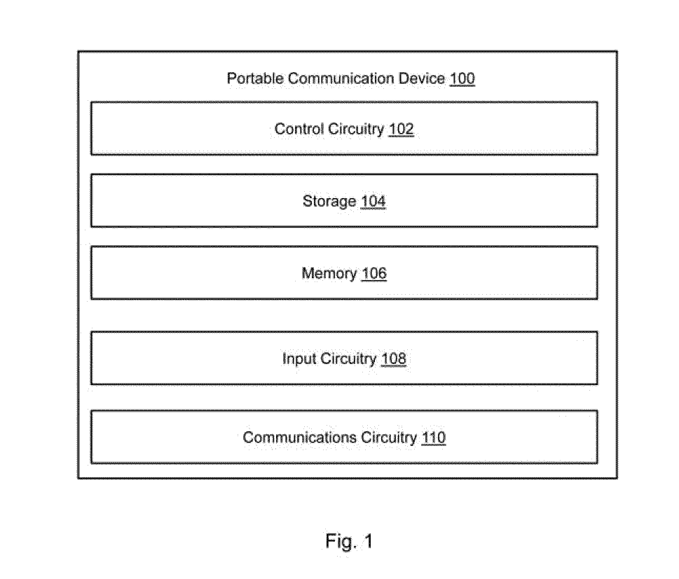

Referring now to the drawings where the showings are for the purpose of describing the preferred embodiment of the proposed invention and not for limiting the same, FIG. 1 is a schematic view of an illustrative portable communication device 100 for providing an application operative to interface with a social gifting system in accordance with some embodiments of the invention. The portable communication device 100 includes control circuitry 102, storage 104, memory 106, input/output (“I/O”) circuitry 108 and communications circuitry 110.

Those skilled in the art would appreciate that the portable communication device 100 of FIG. 1 may include one or more components which may not be shown here. These one or more components of the portable communication device 100 may be combined or omitted with the components shown in FIG. 1. Examples of these one or more components include but may not be limited to motion detection components, a power supply such as a battery or kinetics, a display, bus, a positioning system, a camera, and an input mechanism. For the sake of simplicity, only one of each of the components is shown in FIG. 1.

The portable communication device 100 includes any suitable type of electronic device. Examples of the portable communication device 100 include but may not be limited to a digital media player (e.g., an IPOD, made available by Apple Inc. of Cupertino, Calif.), a personal e-mail device (e.g., a BLACKBERRY, made available by Research in Motion of Waterloo, Ontario), a personal data assistant (“PDA”), a cellular telephone, a SMARTPHONE, a handheld gaming device, a digital camera, a laptop computer, and a tablet computer. In another embodiment of the present invention, the portable communication device 100 can be a desktop computer. In another embodiment of the present invention, the portable communication device 100 can be a point-of-sale (POS) system.

From the perspective of this invention, the control circuitry 102 includes any processing circuitry or processor operative to control the operations and performance of the portable communication device 100. For example, the control circuitry 102 may be used to run operating system applications, firmware applications, media playback applications, media editing applications, or any other application. In some embodiments of the present invention, the control circuitry 102 drives a display and process inputs received from a user interface.

From the perspective of this invention, the storage 104 includes one or more storage mediums including a hard-drive, solid state drive, flash memory, permanent memory such as ROM, any other suitable type of storage component, or any combination thereof. Storage 104 may store, for example, media data (e.g., music and video files), application data (e.g., for implementing functions on the portable communication device 100), firmware, user preference information data (e.g., media playback preferences), authentication information (e.g. libraries of data associated with authorized users), lifestyle information data (e.g., food preferences), exercise information data (e.g., information obtained by exercise monitoring equipment), transaction information data (e.g., information such as credit card information), wireless connection information data (e.g., information that may enable portable communication device 100 to establish a wireless connection), subscription information data (e.g., information that keeps track of podcasts or television shows or other media a user subscribes to), contact information data (e.g., telephone numbers and email addresses), calendar information data, and any other suitable data or any combination thereof.

From the perspective of this invention, the memory 106 includes cache memory, semi-permanent memory such as RAM, and/or one or more different types of memory used for temporarily storing data. In embodiments of the present invention, the memory 106 may also be used for storing data used to operate electronic device applications, or any other type of data that may be stored in the storage 104. In embodiments of the present invention, the memory 106 and the storage 104 may be combined as a single storage medium.

From the perspective of this invention, the I/O circuitry 108 may be operative to convert (and encode/decode, if necessary) analog signals and other signals into digital data. In some embodiments of the present invention, the I/O circuitry 108 may also convert digital data into any other type of signal, and vice-versa. For example, the I/O circuitry 108 may receive and convert physical contact inputs (e.g., from a multi-touch screen), physical movements (e.g., from a mouse or sensor), analog audio signals (e.g., from a microphone), or any other input. The digital data may be provided to and received from the control circuitry 102, the storage 104, memory 106, or any other component of portable communication device 100.

It may be noted that the I/O circuitry 108 is illustrated in FIG. 1 as a single component of portable communication device 100; however those skilled in the art would appreciate that several instances of I/O circuitry 108 may be included in portable communication device 100.

The portable communication device 100 may include any suitable interface or component for allowing a user to provide inputs to the I/O circuitry 108. The portable communication device 100 may include any suitable input mechanism. Examples of the input mechanism include but may not be limited to a button, keypad, dial, a click wheel, and a touch screen. In some embodiments of the present invention, the portable communication device 100 may include a capacitive sensing mechanism, or a multi-touch capacitive sensing mechanism.

In some embodiments of the present invention, the portable communication device 100 may include specialized output circuitry associated with output devices such as, for example, one or more audio outputs. The audio output may include one or more speakers built into the portable communication device 100, or an audio component that may be remotely coupled to the portable communication device 100.

The one or more speakers can be mono speakers, stereo speakers, or a combination of both. The audio component can be a headset, headphones or ear buds that may be coupled to communications device with a wire or wirelessly.

In some embodiments of the present invention, the I/O circuitry 108 may include display circuitry for providing a display visible to the user. For example, the display circuitry may include a screen (e.g., an LCD screen) that is incorporated in the portable communication device 100.

The display circuitry may include a movable display or a projecting system for providing a display of content on a surface remote from portable communication device 100 (e.g., a video projector). In some embodiments of the present invention, the display circuitry may include a coder/decoder to convert digital media data into analog signals. For example, the display circuitry may include video Codecs, audio Codecs, or any other suitable type of Codec.

The display circuitry may include display driver circuitry, circuitry for driving display drivers, or both. The display circuitry may be operative to display content. The display content can include media playback information, application screens or pages for applications implemented on the electronic device, information regarding ongoing communications operations, information regarding incoming communications requests, or device operation screens or pages under the direction of control circuitry 102. Alternatively, the display circuitry may be operative to provide instructions to a remote display.

From the prospective of this invention, the communications circuitry 110 may include any suitable communications circuitry operative to connect to a communications network and to transmit communications (e.g., voice or data) from portable communication device 100 to other devices within the communications network. Communications circuitry 110 may be operative to interface with the communications network using any suitable communications protocol. Examples of the communications protocol include but may not be limited to Wi-Fi, BLUETOOTH, radio frequency systems, infrared, LTE, GSM, GSM plus EDGE, CDMA, and quadband.

In some embodiments of the present invention, the communications circuitry 110 may be operative to create a communications network using any suitable communications protocol. For example, communications circuitry 110 may create a short-range communications network using a short-range communications protocol to connect to other devices. For example, communications circuitry 110 may be operative to create a local communications network using the BLUETOOTH protocol to couple portable communication device 100 with a BLUETOOTH headset.

It may be noted that the portable communication device is shown to have only one communication operation; however, those skilled in the art would appreciate that the portable communication device 100 may include one more instances of communications circuitry 110 for simultaneously performing several communications operations using different communications networks. For example, the portable communication device 100 may include a first instance of communications circuitry 110 for communicating over a cellular network, and a second instance of communications circuitry 110 for communicating over Wi-Fi or using BLUETOOTH.

In some embodiments of the present invention, the same instance of communications circuitry 110 may be operative to provide for communications over several communications networks. In some embodiments of the present invention, the portable communication device 100 may be coupled a host device for data transfers, synching the communications device, software or firmware updates, providing performance information to a remote source (e.g., providing riding characteristics to a remove server) or performing any other suitable operation that may require portable communication device 100 to be coupled to a host device. Several portable communication devices may be coupled to a single host device using the host device as a server. Alternatively or additionally, the portable communication device 100 may be coupled to several host devices (e.g., for each of the plurality of the host devices to serve as a backup for data stored in the portable communication device 100).

In some embodiments of the present invention, an electronic device (e.g., portable communication device 100 of FIG. 1) may include an integrated application operative to interface with a real-time social gifting system. In some embodiments of the present invention, the integrated application may perform a predefined method which may further be performed by a real-time social gifting system.

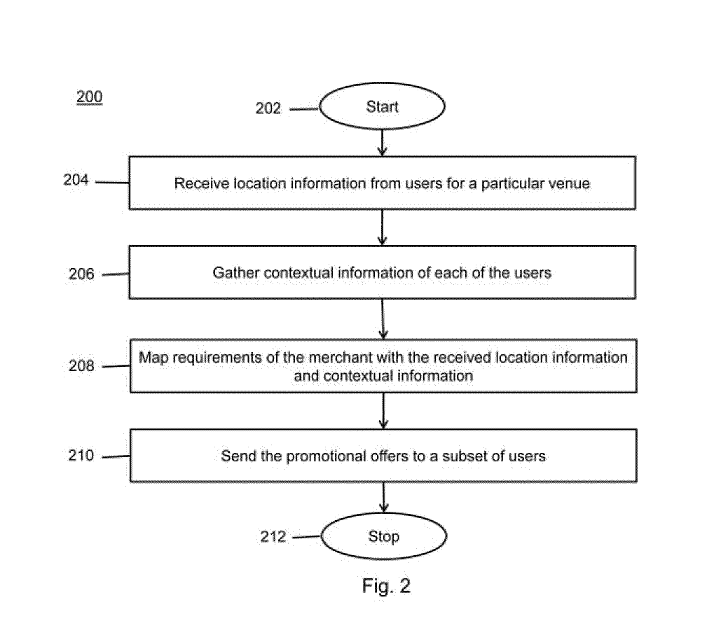

FIG. 2 illustrates a flow chart 200 for sending targeted and contextual promotional offers on behalf of a merchant in accordance with various embodiments of the present invention. It may be noted that references will be made to FIG. 1 for explaining the various process steps associated with FIG. 2. In addition, those skilled in the art would appreciate that the various process steps explained in flow chart 200 will have more or less number of process steps which may explain the process as a whole.

The flow chart initiates at step 202. At step 204, location information of users is collected. Each of the users is associated with a portable communication device by which their respective location is tracked at a particular venue. The location information is determined by getting permission from the users associated with their respective portable communication devices. For example, a user “X” may plan to visit Dodger Stadium in Los Angeles, Calif., USA to watch a baseball game. As soon as the user X enters the Dodger stadium, the user X may activate a permission session in the portable communication device 100 to track his location in the stadium. In the current example, the stadium may have different sections. The information regarding the current section in which the user is seated in the stadium is gathered. It may be noted that the other attributes related to the location information may be mapped and collected. For example, it may be mapped that the current section in which the user is seated is an economy section, a privileged section, a VIP section, and the like. In an embodiment of the present invention, the user provides the location information. For example, user X may have the seating layout of the Dodger stadium. He may identify his exact location in the stadium from the layout and provide the information.

In an embodiment of the present invention, the location information of the user is collected by using GPS technology. In another embodiment of the present invention, the location information of the user is collected based on any of the current technologies presently known in the art.

It may be noted that the above embodiment is explained by using an example of user X who is using the portable communication device 100. However, those skilled in the art would appreciate that location information related to multiple users is collected. Each of these users will be associated with their portable communication devices and will activate a permission session to track their location in the stadium. In an embodiment of the present information, each of the users may provide their respective location information on real-time basis.

In another embodiment of the present invention, the location information may be collected from the social networking services. The information from the social networking services can be collected on real-time basis. For example, the user X may have added an event/post on the user's FACEBOOK page. The exemplary event/post can be “Attending the game in Dodger Stadium on 5 Mar. 2012”. A hint/clue regarding the location is taken from the social networking services and is confirmed by the location tracking techniques. In yet another embodiment of the present invention, a hint/clue regarding the location is taken from the social networking services and is confirmed by the user.

At step 206, contextual information of each user is gathered. In an embodiment of the present invention, the contextual information can be the preferences of the users. The preferences may be related to lifestyle information data (e.g., food preferences), exercise information data, reading habits, and the like. For example, the user might have a preference for: Mexican food, reading motivational autobiographies, baseball, and the like. In an embodiment of the present invention, preferences are provided by the user. In another embodiment of the present invention, preferences are collected from the social networking services. In yet another embodiment of the present invention, preferences are collected from both the user and social networking services.

In an embodiment of the present invention, preferences can be changed by the user on real-time basis. Continuing the above-stated example, user X may provide the preferences of food, music, shoes, clothes and the like. The user X may change his preferences depending on the location. The preferences of user X may be collected from his FACEBOOK account or other social network account. In this embodiment of the present invention, user X may allow the present invention to collect his preferences from the FACEBOOK account.

At step 208, the requirements of the merchant are mapped with the received location information and contextual information. In an embodiment of the present invention, mapping is done based on predefined criteria. The predefined criterion is based on the combination of location and contextual information. Continuing the above stated example, a food merchant present in a VIP section of the Dodger stadium may like to send the promotional offers to the spectators who like Mexican food. This criterion is mapped from the collected location and contextual information of the multiple users. In another exemplary scenario, the governing authority of the Dodger stadium may like to interact with the audience seated in different sections. The governing authority may like to send a promotional offer of changing the section of the user from the economy section to the VIP section. In this scenario, the criterion is mapped based on the location and the contextual information of the multiple users.

At step 210, promotional offers are sent to the users who map on to the predefined criteria. In the above-stated example, the promotional offers are sent to the users who like Mexican food and are seated in the economy section. In an embodiment of the present invention, the promotional offers are sent to a subset of the users who are seated in the economy section. Based on the responses received on the promotional offer by the subset of the users, the promotional offers are sent to the remaining users who map on the predefined criteria. It may be noted that the flow chart 200 has been explained with the help of taking some exemplary scenarios. However, those skilled in the art that the scope of the flow chart 200 is not limited to these exemplary scenarios. For example, the merchant may set criteria on different combinations of location and contextual information.

In an embodiment of the present invention, the merchant may send the promotional offers with a time frame or some other criteria. One such exemplary offer can be “Eat Mexican pizzas for a discount of 30%. Offer valid for 10 minutes.” The merchant may send the offer to the user who has preference for Mexican food. This offer may require the users to act immediately since the offer is good for the next 10 minutes. The offer may have a countdown timer and once the time reaches zero minutes and zero seconds, the offer becomes invalid. The user may opt for redeeming the offer within the given time frame. It may be noted that promotional offers in the above example are explained for a time frame constraint. However, those skilled in the art would appreciate that some other criteria (frequency of the user visiting Dodger stadium, and the like) may be added to the promotional offers. In another example, the governing authority of the Dodger stadium may advertise “Change your seat from economy section to VIP section for USD10. Offer valid for 10 minutes. Two previous tickets of Dodger stadium required.” In an embodiment of the present invention, the user may share the deal with any of his friends/relatives who are present in the stadium. At step 212, the flow chart 200 terminates.

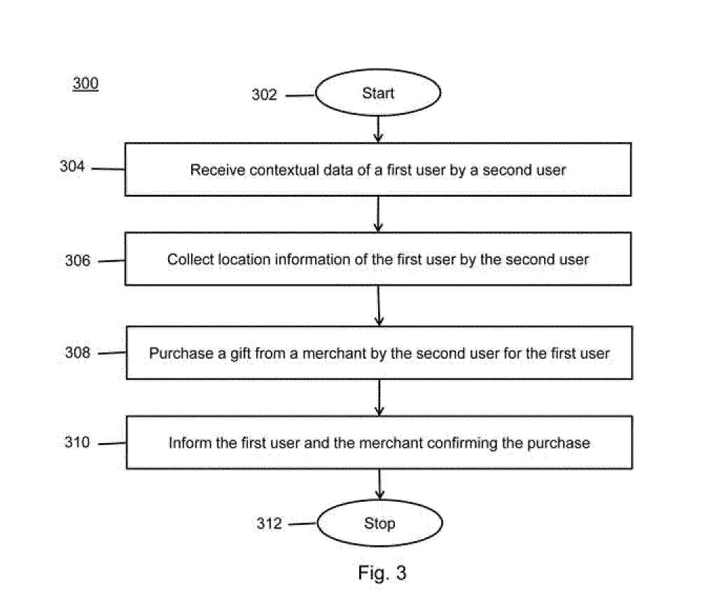

FIG. 3 illustrates a flow chart 300 for purchasing a gift for the user in accordance with some embodiments of the present invention. It may be noted that references will be made to FIG. 1 and FIG. 2 for explaining the various process steps associated with the flow chart 300. In addition, those skilled in the art would appreciate that the various process steps explained in flow chart 300 will have more or less number of process steps which may explain the process as a whole.

The flow chart initiates at step 302. At step 304, contextual data of a first user is collected by a second user. As explained in the flow chart 200, the contextual information can be the preferences of the first user. As explained, the preferences may be related to sports, food, reading habits, clothes, music and the like. For example, the preference can be a liking of the first user: eating Mexican food, reading motivational autobiographies, and the like. In an embodiment of the present invention, the preferences are provided by the first user. In another embodiment of the present invention, the preferences are collected from the social networking services. In yet another embodiment of the present invention, preferences are collected from both the user and social networking services.

Similar to the contextual information explained in the flow chart 200, in an embodiment of the present invention, preferences can be changed by the user on real-time basis. Extending the exemplary scenario, the user X may be the first user and may provide the preferences of food, music, shoes, clothes and the like. The user X may change his preferences depending on the location. The preferences of user X may be collected from his FACEBOOK account or other social network account. In this embodiment of the present invention, the preferences of the user X are collected from his FACEBOOK account. All these preferences are collected by a second user, say user “Y.”

It may be noted that the flow chart 300 is explained by taking a first user and a second user into consideration. However, those skilled in the art would appreciate that the contextual information of the first user is collected by multiple users. Similarly, the second user may collect the contextual information of multiple users.

In an embodiment of the present invention, the first user may allow the second user to collect the contextual information. In another embodiment of the present invention, the second user may collect the contextual information of the first user without his permission. In yet another embodiment of the present invention, the first user may allow the second user to collect a subset of the contextual information.

At step 306, location information of the first user is gathered and provided to the second user. In an embodiment of the present invention, the first user activates a permission session in the first portable communication device. The first user allows the second user to view the first user's location. For example, user X (herein the first user) while visiting to Dodger Stadium in Los Angeles, Calif., USA activates the permission session in the portable communication device 100 to track his location in the stadium. In the current example, the stadium may have different sections. The information regarding the current section in which the user X is seated in the stadium is gathered and provided to the user Y. In an embodiment of the present invention, it may be noted that the other attributes related to the location information may be mapped and collected. For example, it may be mapped that the current section in which the user X is seated is an economy section.

In an embodiment of the present invention, the location information of the user X is collected by using GPS technology and transmitted to the user Y. In another embodiment of the present invention, the location information of the user X is collected and transmitted to the user Y based on any of the current technologies presently known in the art. In another embodiment of the present invention, the first user may provide the location information. For example, user X may provide the seat number (or any other details about his seat) based on the layout of the Dodger stadium. This information may be provided to the second user.

In another embodiment of the present invention, the location information of the user X may be collected from the social networking services. The information from the social networking services can be collected on real-time basis. For example, the user X may have added an event/post on his FACEBOOK page. As explained earlier, the exemplary event/post can be “Attending the game in Dodger Stadium on 5 Mar. 2012.” The same may be confirmed by the location tracking techniques and provided to the user Y.

At step 308, a gift is purchased from the merchant by the second user based on the predefined criteria. In an embodiment of the present invention, the predefined criteria are based on the combination of the location and the contextual information of the first user. Extending the above stated example, the merchant may provide a list of items that can be purchased by the user Y for the user X.

In an embodiment of the present invention, the merchant may provide the list of the items/menu to the second user based on the contextual information of the first user. In another embodiment of the present invention, the second user may purchase an item based on the contextual and location information of the first user. In the above stated example, user Y may purchase a team t-shirt for the user X as the user X is in the sports stadium and has the preference of the team, of which he is a sports fan.

In an embodiment of the present invention, the merchant may be in the vicinity of the first user. In this embodiment of the present invention, the second user may have a list of the merchants in the vicinity of the first user. The second user may have the list of all the items of all the merchants in the vicinity of the first user. The second user may select one or more items from a merchant which is in the vicinity of the first user. In an embodiment of the present invention, other information about the merchant is provided to the second user. This information include but may not be limited to the attributes of the merchant such as contact information, type of merchant, and number of people who have bought the items from the merchant. In the above stated example, user Y may have a list of all the merchants (along with their list of items and other details) which are in the economy section of the Dodger stadium. In an embodiment of the present invention, the second user may purchase one or more items online by using the technologies presently known in the art.

At step 310, the confirmation of the purchase of one or more items is sent to the first user and the merchant. In the above stated example, as soon as the user Y purchases a team t-shirt for the user X, a notification is sent to the user X stating that the user Y has purchased a team t-shirt from the merchant situated in the economy section of Dodger Stadium. In addition, the user X may be sent a purchase authentication code. In an embodiment of the present invention, the merchant situated in the VIP section may receive a confirmation regarding the purchase made by the user Y. In addition, the merchant may get the same purchase authentication code which is received by the user X. In this case, user X may collect the gift (a team t-shirt) from the merchant by matching the purchase authentication code. In an embodiment of the present invention, the merchant may deliver the gift to the user X after matching the purchase authentication code.

In an embodiment of the present invention, the purchase authentication code may be sent to the first user by Short Messaging Service (SMS), email, or by any other technology presently known in the art. It may be noted that the delivery of the gift may be done only after correct authentication of the first user. Although, in the above stated example, the authentication is done by matching a purchase authentication code; however, those skilled in the art will appreciate that the correct authentication is done by using the current technologies presently known in the art. In an example, the first user may have to show his driver's license and the like.

In an embodiment of the present invention, once the first user receives the gift, he may send an acknowledgement of the receipt of the gift to the user Y by an email, SMS, or by any other technology currently known in the art. In another embodiment of the present invention, the merchant sends an acknowledgment to the second user after delivering the gift to the first user by an email, SMS, or by any other technology currently known in the art. In yet another embodiment of the present invention, the first user and the merchant sends an acknowledgment to the second user. At step 312, the flow chart 300 terminates.

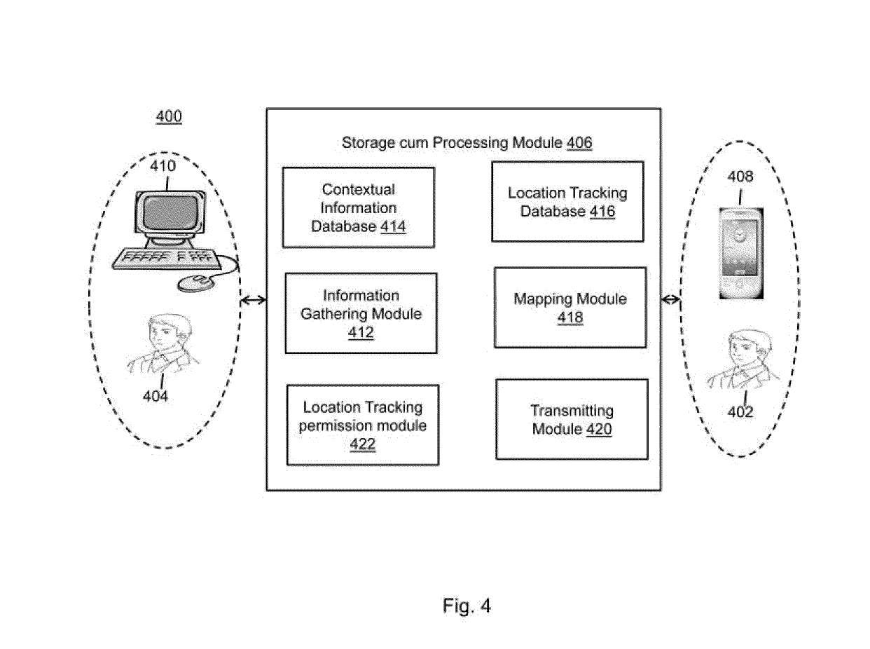

FIG. 4 illustrates a social gifting system 400 for sending targeted and contextual promotional offers on behalf of a merchant in accordance with various embodiments of the present invention. It may be noted that references will be made to FIG. 1, FIG. 2, and FIG. 3 for explaining the various elements/modules associated with the social gifting system 400. In addition, those skilled in the art would appreciate that the various elements/modules explained in the social gifting system 400 will have more or less number of elements/modules which may explain the social gifting system 400 as a whole.

The social gifting system 400 includes a user 402, a merchant 404, and storage/processing module 406. The user 402 is associated with the portable communication device 408. The merchant 404 is associated with the portable communication device 410. In an embodiment of the present invention, the portable communication device 408 associated with the user 402 interacts directly with the portable communication device 410 associated with the merchant 404. In another embodiment of the present invention, the portable communication device 408 associated with the user 402 interacts indirectly with the portable communication device 410 associated with the merchant 404 via the storage/processing module 406. Examples of the portable communication devices 408 and 410 may include a computer, mobile phone, a laptop, a tablet computer, and the like. The interaction between the portable communication devices 408 and 410 and with the storage/processing module 406 can be performed by using the technologies presently known in the art which may be not be limited to Wi-Fi, BLUETOOTH, radio frequency systems, infrared, GSM, GSM plus EDGE, CDMA, and quadband.

In an embodiment of the present invention, the portable communication devices 408 and 410 may be provided with an interface to interact with the storage/processing module 406. The storage/processing module 406 may be a server or any other storage device that may have the capability of storing and processing and is presently known in the art.

In an embodiment of the present invention, the storage/processing module 406 enables the sending of targeted and contextual promotional offers on behalf of a merchant. The storage/processing module 406 includes an information gathering module 412, a contextual information database 414, a location database 416, a location tracking permission module 422, a mapping module 418 and a transmitting module 420. It may be noted that the storage/processing module 406 is shown to have the information gathering module 412, the contextual information database 414, and the location database 416, location tracking permission module 422, the mapping module 418 and the transmitting module 420. However, those skilled in the art would appreciate that the storage/processing module 406 may have more or less number of elements which may perform the essential functions.

In an embodiment of the present invention, the information gathering module 412 collects the contextual data of the user 402. As described earlier in the description of FIG. 2 and FIG. 3, the contextual data may relate to the preference of the user 402 and is collected on the real-time basis by the information gathering module 412. As soon as the user 102 changes his preferences, the information gathering module 412 updates the contextual information database 414. All the contextual information of the user 402 is stored in the contextual information database 414. Those skilled in the art would appreciate that the contextual information database 414 may store the contextual information of one or more users.

The information gathering module 412 collects the location information of the user 402. The location information is collected from the sources which have been explained in the description of FIG. 2 and FIG. 3. The location information is collected based on the activation of the location tracking permission module 422. In an embodiment of the present invention, the storage/processing module 406 sends a request to the portable communication device 408 to track the location of the user 402. The user 402 activates the location tracking permission module 422. In another embodiment of the present invention, the user 402 activates a location tracking permission module in the portable communication device 408 on its own. In yet another embodiment of the present invention, the user 402 provides the location information. For example, as explained in the description above, the user 402 may provide the seat number based on the layout of the Dodger stadium.

The location information of the user 402 is stored in the location tracking database 416. In an embodiment of the present invention, the location information of the user 402 is tracked on real-time basis and is stored in the location tracking database 416. The location information is stored in the location tracking database 416 until the time the user 402 deactivates the location tracking permission session on his portable communication device 408. In an embodiment of the present invention, the location tracking session is deactivated automatically once the user 402 leaves a particular venue. In this embodiment of the present invention, the user 402 set a criterion in his portable communication device 408 to deactivate the permission session. The criterion may be based on the time, venue, and the like. Those skilled in the art would appreciate that the location tracking database 416 may store the location information of one or more users. In an embodiment of the present invention, the contextual information and the location information of the user 402 is transmitted to the merchant 408.

The information gathering module 412 may collect the requirements of the merchant 408. The examples of the requirements of the merchant have been explained in the description of FIG. 2 and FIG. 3. The merchant 408 may provide the requirements through the portable communication device 410. The mapping module 418 matches the requirements of the merchant 408 and sends the list of the users satisfying the requirements to the merchant 408. In an embodiment of the present invention, the mapping module 418 maps the requirements of the merchant 408 by the technologies presently known in the art. In an embodiment of the present invention, the transmitting module 420 sends the lists of the users to the merchant 408.

In an embodiment of the present invention, the merchant 408 may send the promotional offers to the users/subset of the users on its own. In another embodiment of the present invention, the merchant 408 may direct the transmitting module 410 to send the promotional offers to the list of the users matching the requirements. In yet another embodiment of the present invention, user 402 may redeem the offers (with or without any constraints) through the storage/processing module 406. In yet another embodiment of the present invention, user 402 may redeem the offers (with or without any constraints) through an independent server or through manual interaction with the merchant 408.

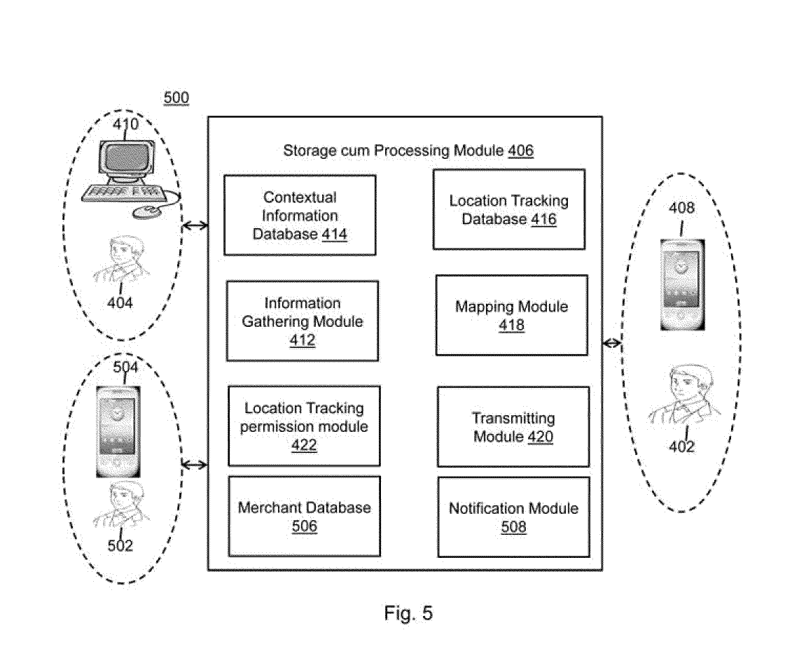

FIG. 5 illustrates a system 500 for purchasing the gift for a user in accordance with some embodiments of the present invention. It may be noted that references will be made to FIG. 1, FIG. 2, FIG. 3 and FIG. 4 for explaining the various elements/modules associated with the system 500. In addition, those skilled in the art would appreciate that the various elements/modules explained in the system 500 will have more or less number of elements/modules which may explain the system 500 as a whole.

The system 500 includes a first user 402, the merchant 404, the storage/processing module 406, and a second user 502. The second user is associated with a portable communication device 504. In an embodiment of the present invention, the portable communication device 504 associated with the second user 502 interacts directly with the portable communication device 410 associated with the merchant 404 and the portable communication device 408 associated with the first user 402. In an embodiment of the present invention, the portable communication device 504 associated with the second user 502 interacts indirectly with the portable communication device 410 associated with the merchant 404 and the portable communication device 408 associated with the first user 402. Examples of the portable communication devices 408, 410 and 504 may include a computer, mobile phone, a laptop, a personal digital assistant (PDA), a SMARTPHONE, a tablet computer, and the like. The interaction between the portable communication devices 408, 410 and 504 and with the storage/processing module 406 can be performed by using the technologies presently known in the art which may be not be limited to Wi-Fi, BLUETOOTH, radio frequency systems, infrared, GSM, GSM plus EDGE, CDMA, optical scanning, LTE and quadband. In an embodiment of the present invention, the portable communication devices 408, 410 and 504 may be provided with an interface to interact with the storage/processing module 406.

In addition to the system elements explained in the storage/processing module 406 of FIG. 4, the system 500 includes a merchant database 506. The merchant database 506 includes a list of the merchants and the respective services offered by these merchants. In addition, the merchant database 506 includes a list of the information regarding the various attributes associated with these merchants. The location information of these merchants is stored in the location tracking database 416. As explained in the description of FIG. 4, the contextual information and the location information of the first user 402 is stored in the respective databases. In an embodiment of the present invention, the second user 502 views the contextual information and location information of the first user 402. Based on the contextual and location information, the second user 502 purchase gift(s) by viewing the list of the merchants along with the list of items present in the vicinity and is relevant in context of the preferences of the first user 402. For the sake of simplicity, the merchant 408 is shown to be present in the vicinity of the first user 402 and may have a list of items which the first user 402 prefers.

On purchasing a gift from the list of items by the second user 502, a notification module 508 sends the notification to the first user 402 and the merchant 408. In an embodiment of the present invention, the notification module 508 generates the purchase authenticating code and sends the purchase authenticating code to the first user 402 and the merchant 408 by Short Messaging Service (SMS), email, or by any other technology presently known in the art. Accordingly, the first user 402 shows the purchase authentication code to the merchant 408 along with the other authentication documents. On correct authentication, the gift is delivered to the first user 402. The notification module 508 generates and sends a notification message acknowledging the delivery of the gift. Those skilled in the art will appreciate that the notification module 508 may not only generate a purchase authentication code but may also generate some other authentication technique presently known in the art so that the gift may be delivered to the actual recipient. It may be noted that the purchase of the gift by the second user 502 is done by a payment gateway that may or may not be associated with the storage/processing module 406.

In an embodiment of the present invention, the user may have to download the integrated application operative to interface with a real-time social gifting system 400. In some embodiments of the present invention, the integrated application may perform a predefined method which may further be performed by a real-time social gifting system 400.

For the sake of simplicity and explanation, the integrated application may be referred here as a mobile phone application (hereinafter ‘MPA’). Those skilled in the art would appreciate that the integrated application can be downloaded to any portable communication device. The MPA will enable the process (flow charts 200 and 300) and systems 400 and 500 to enable the receiving of targeted advertisements and buying and selling of items based on the real-time contextual and location information.

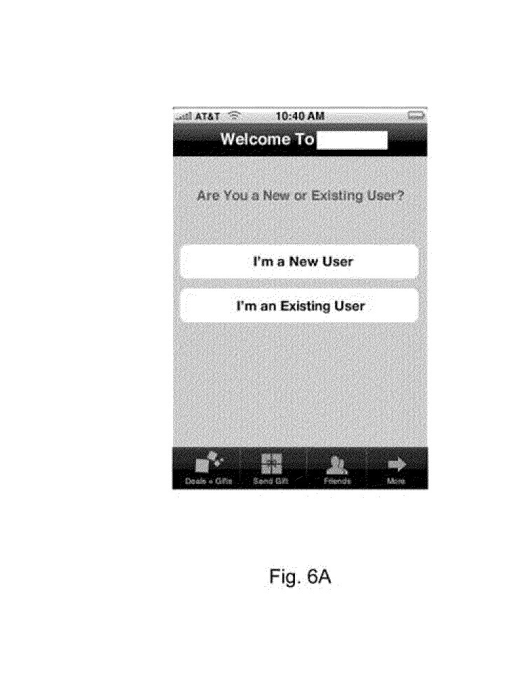

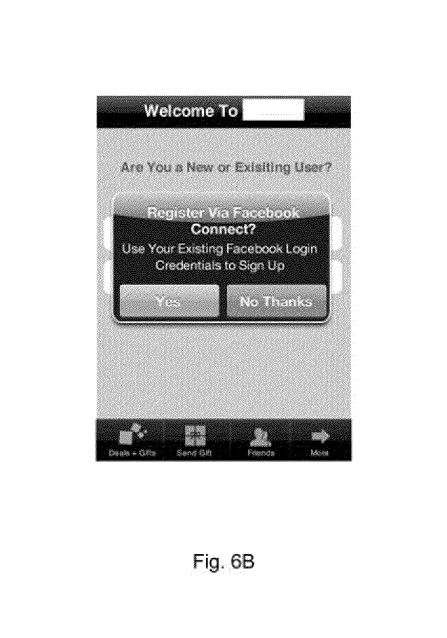

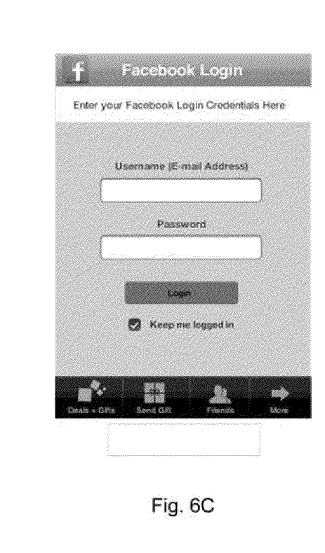

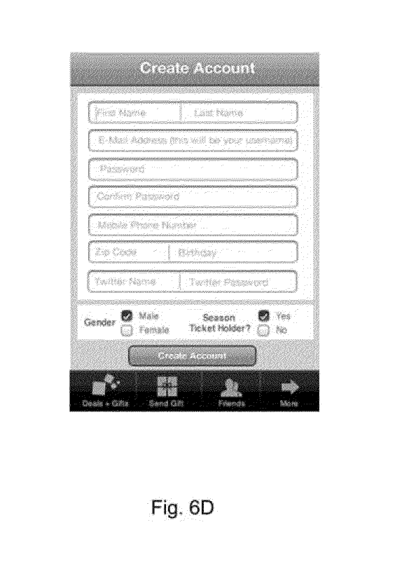

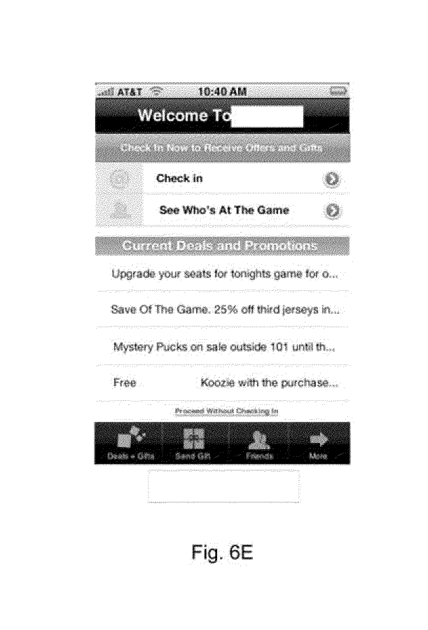

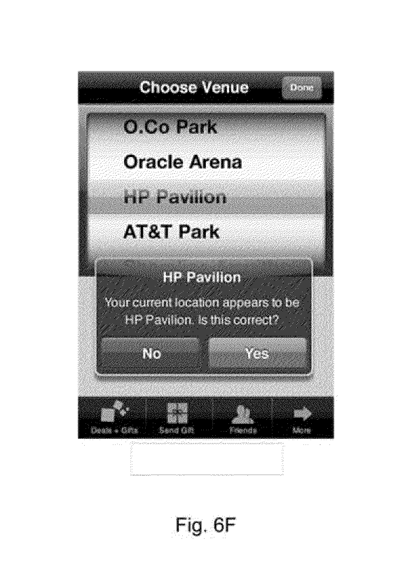

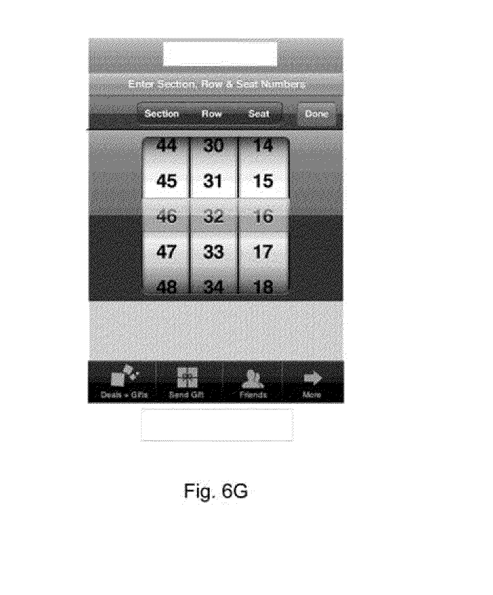

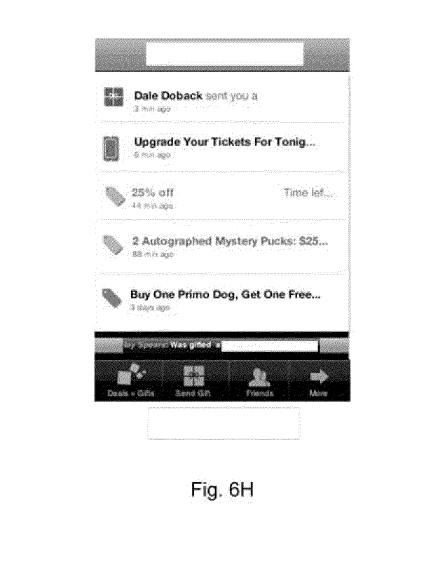

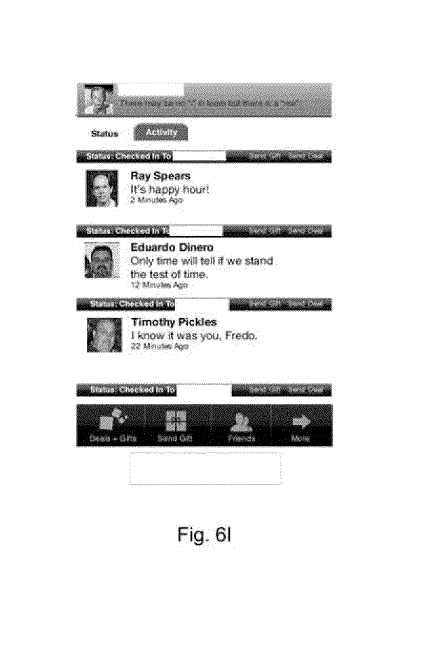

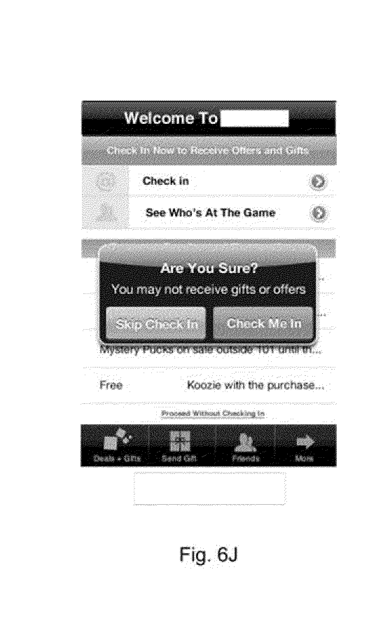

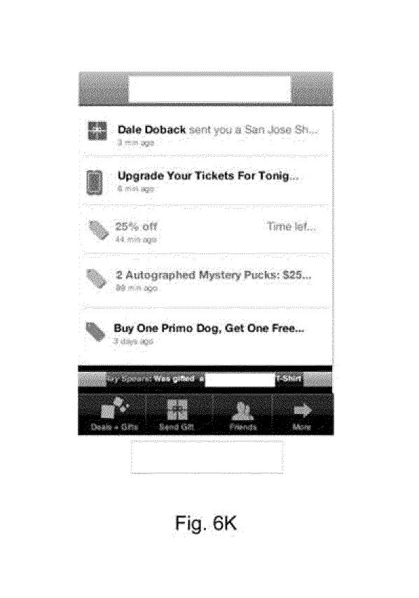

Referring to FIGS. 6A-6K, the snapshots of the user interface which the user will view while interacting with the MPA are shown. It may be noted that the term ‘user’ may correspond to the buyer of the gift (second user 502 of FIG. 5) or the recipient of the gift (user 402 of FIG. 4). Moreover, the word ‘page’ refers to a display/list of activities that the user will see on his screen of the mobile phone while interacting with MPA.

As shown in the FIG. 6A, on downloading the MPA, the user may be provided with two options: ‘I'm a New User’ and ‘I′m an Existing User’.

For the option of the ‘I'm a New User’: As shown in FIG. 6B, a page that asks if the user has an existing FACEBOOK or other social network account may be displayed. If the user has a FACEBOOK account or other social network account, the MPA may prompt the user for his FACEBOOK ID or other social network ID and password (shown in FIG. 6C). After entering the same, MPA may ask present to the user a ‘create account screen’ (shown in FIG. 6D). If the user declines to register via FACEBOOK or another social network, MPA may take the user directly to ‘Create account’ page and may skip asking for the FACEBOOK ID and password or other social network ID and password. Once the user successfully creates the account, the user may be brought to a page (shown in FIG. 6E) displaying the current discount deals based on his location and contextual information.

On this page (FIG. 6E), the user may have two options: a) Check In and b) See Who's at the Game. If the user chooses the “Check In” option, he may be asked about the venue (shown in FIG. 6F). Once the user selects the venue, the MPA may prompt the user to enter his seat information (shown in FIG. 6G). As soon as the user selects the seat number, the MPA may provide the user with a page (shown in 6H) having the history of the items gifted to/by him and some of the promotional offers recommended by merchants and sent to the user on behalf of a merchant based on real-time contextual and location information.

If the user chooses “See Who's at the Game,” the MPA may land the user on a friends page showing the activity of different users (shown in FIG. 61). If the user chooses “I′d like to proceed without checking in” which is at the bottom of the check in screen, the page shown in FIG. 6J may be displayed. If the user clicks on the “Check Me In” button, the user may be provided with a “Choose Venue” page (shown in FIG. 6F). If the user clicks on the “Skip Check-In” button, the user may be provided with the page shown in FIG. 6K.

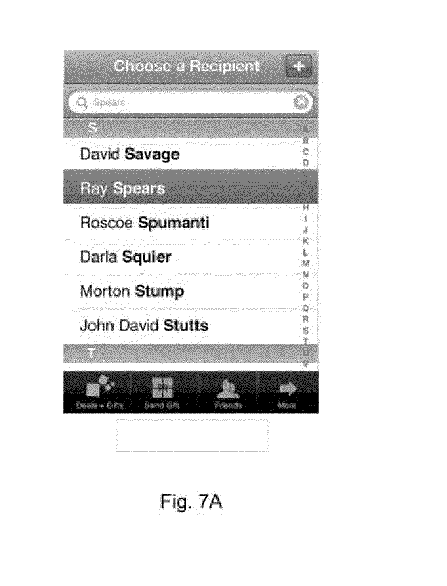

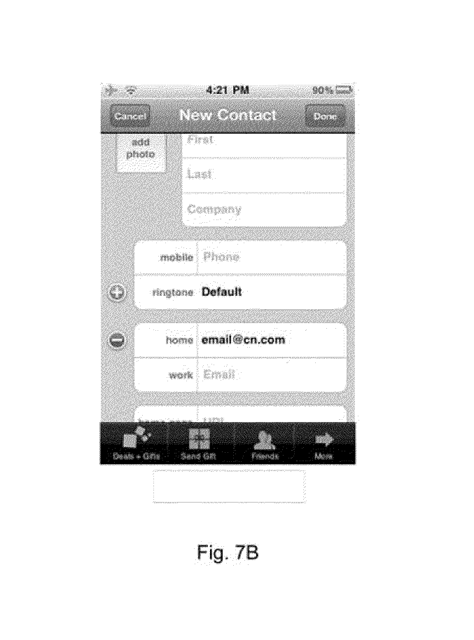

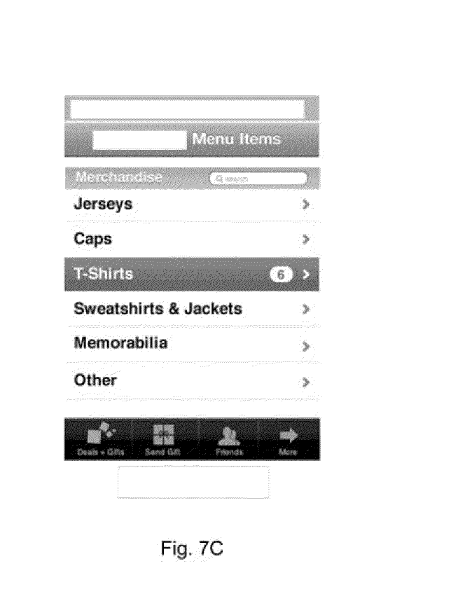

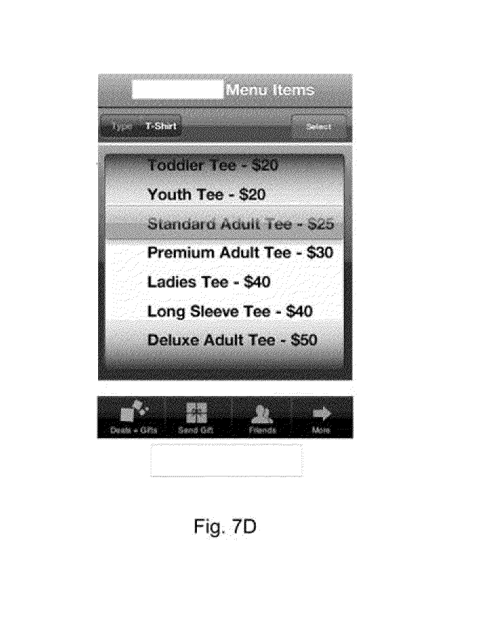

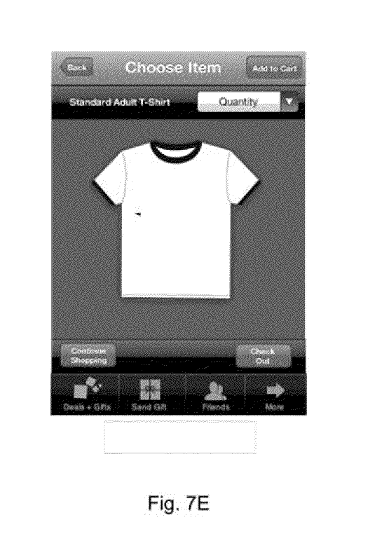

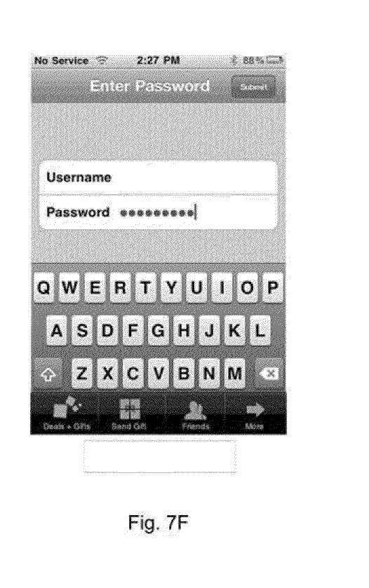

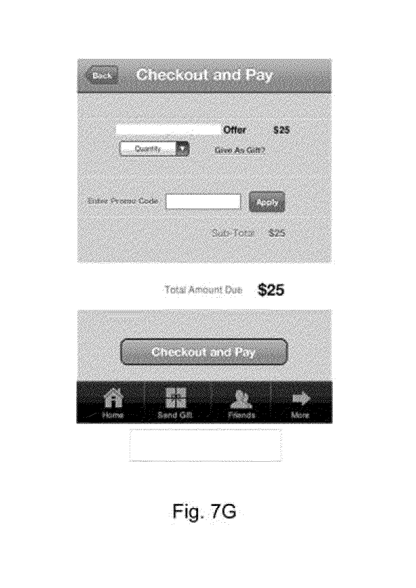

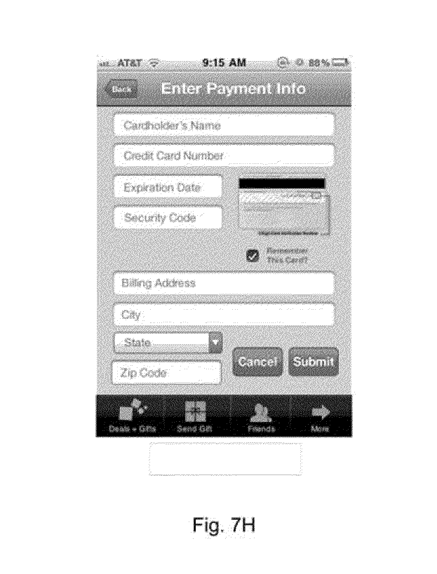

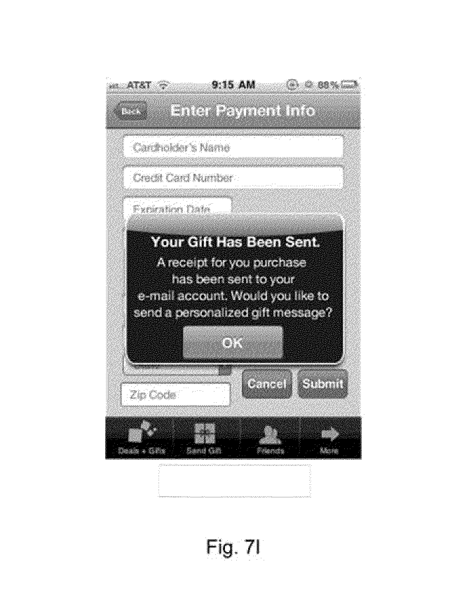

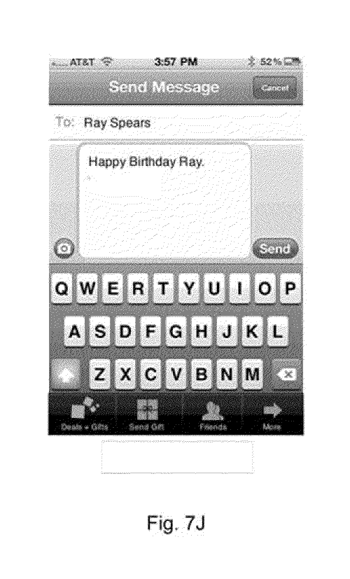

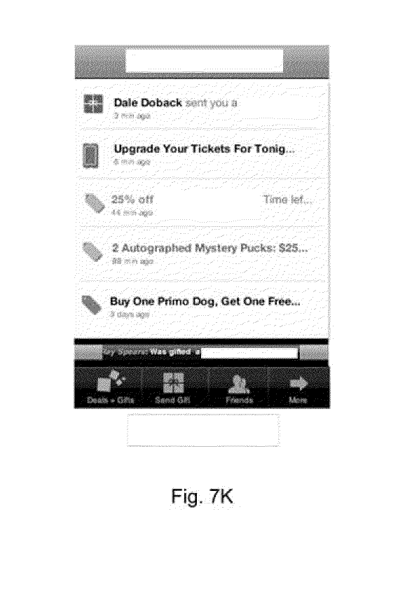

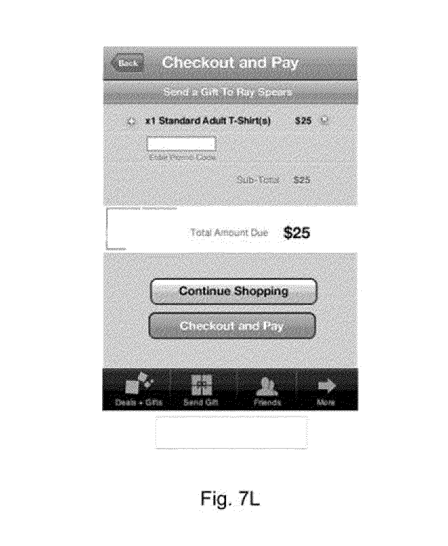

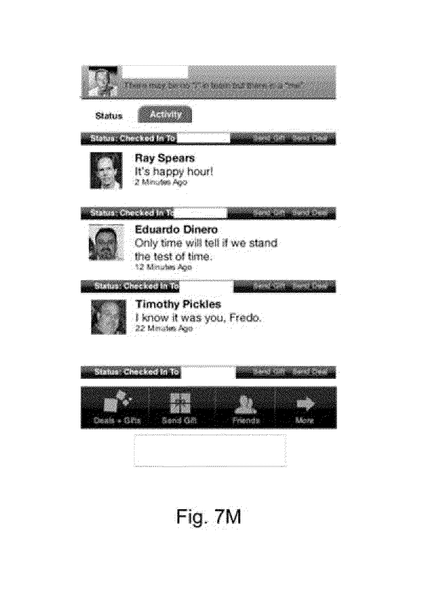

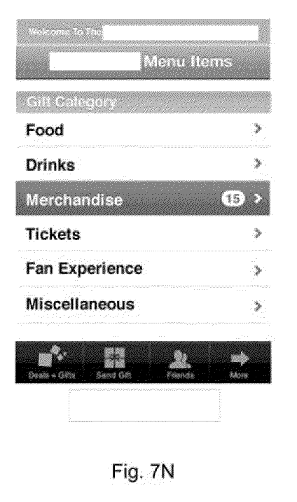

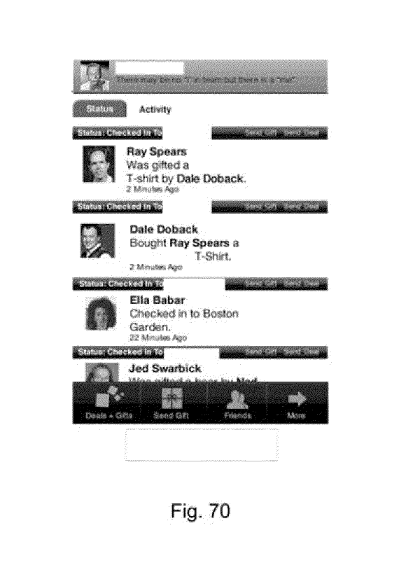

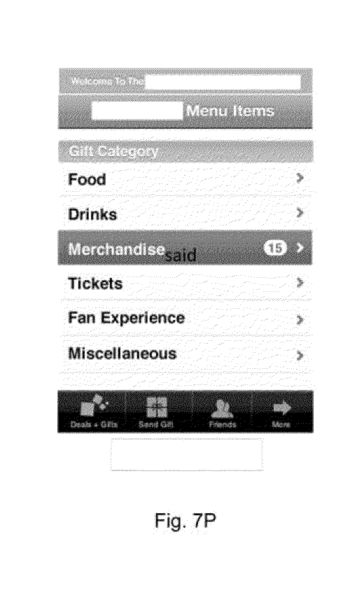

Referring to FIGS. 7A-7P, snapshots of the pages that the user will view to send a gift during his interaction with the MPA are shown. It may be noted that the snapshots provided in the Figures show the mechanism for buying or delivering the gift. However, those skilled in the art would appreciate that the mechanism by which the method/system is implemented may differ or may be upgraded as per the convenience of the user. In addition, the sequence of steps associated with the MPA for buying and delivering the gift may vary as per the convenience of the user.

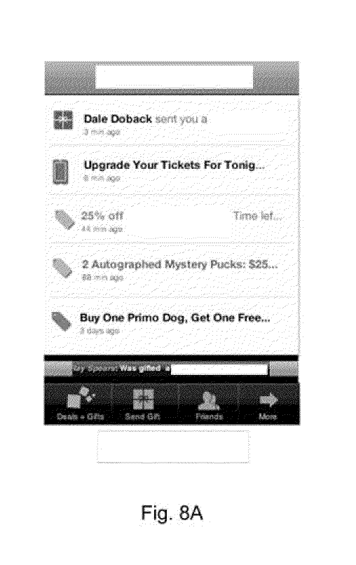

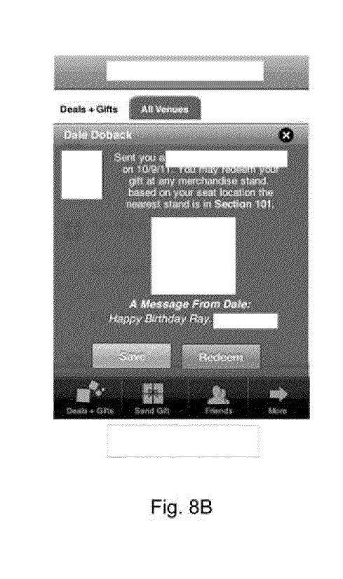

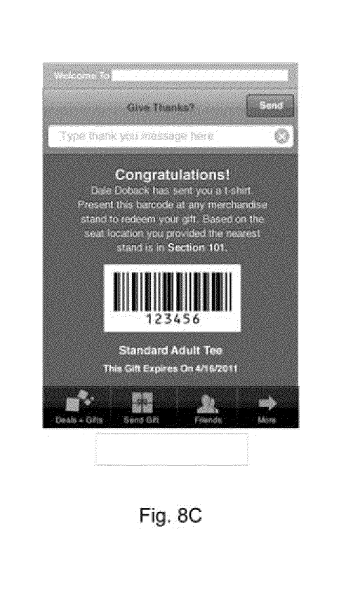

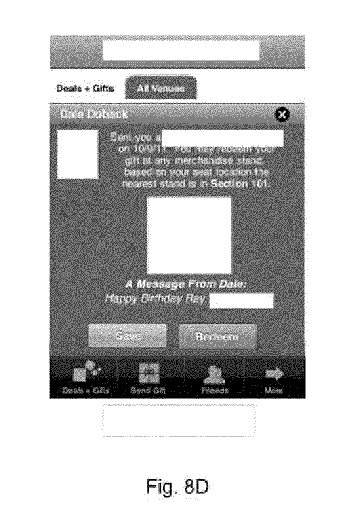

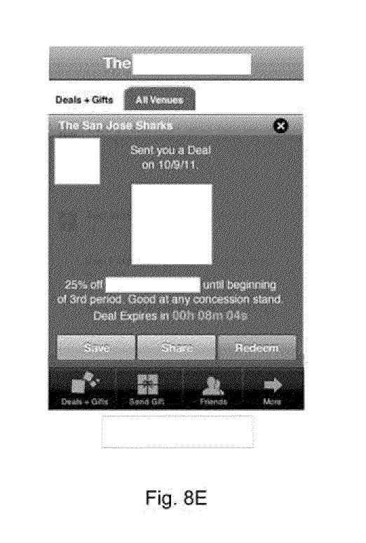

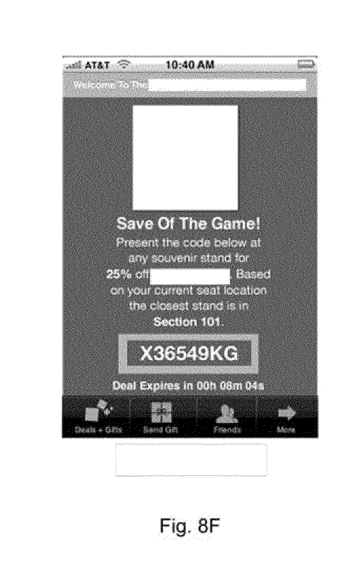

Referring to FIGS. 8A-8F, the snapshots of the user interface which the user will view to redeem the gift while interacting with the MPA is shown.

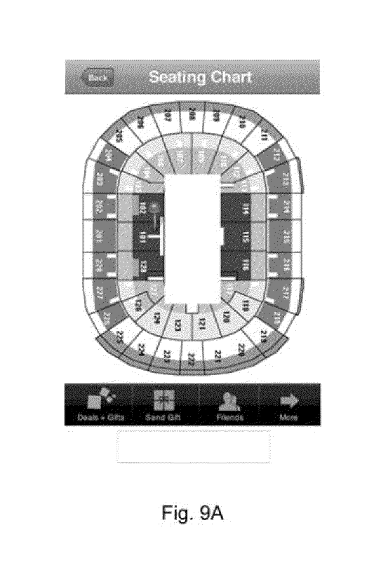

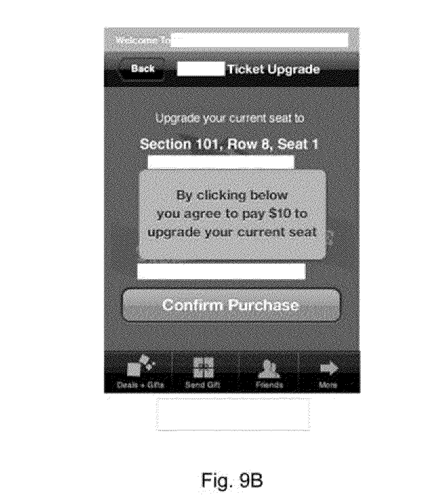

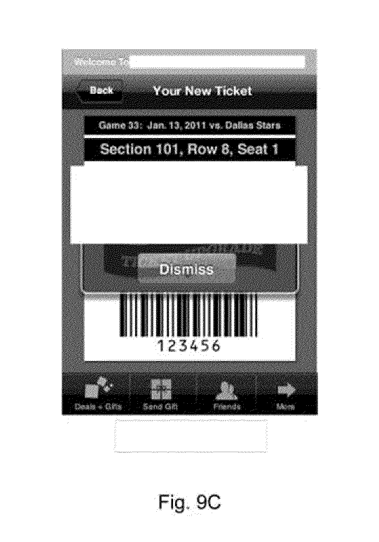

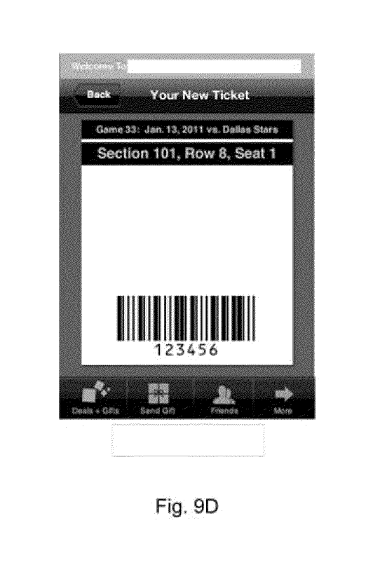

Referring to FIGS. 9A-9D, the snapshots of the user interface which the user will view to upgrade his seats while interacting with the MPA is shown.

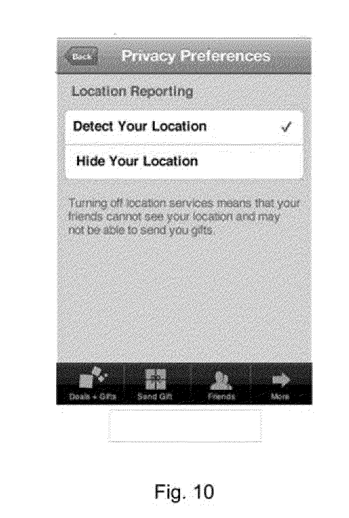

Referring to FIG. 10, the snapshots of the user interface that the user will view to enable or disable permission to detect his location while interacting with MPA is shown.

It may be noted that the snapshots provided in the FIGS. 6A-6K, 7A-7P, 8A-8F, 9A-9D, 10 provide a mechanism of implementing the invention via the MPA. However, those skilled in the art would appreciate that the mechanism by which the invention is implemented may differ or may be upgraded as per the convenience of the user. In addition, the sequence of steps associated with the MPA may vary as per the convenience of the user.

It will be appreciated that the above mentioned system for real-time social gifting system may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of a method for redistribution of communication devices in a wireless network differently. Alternatively, some or all the functions can be implemented by a state machine that has no stored program instructions, or in one or more application-specific integrated circuits (ASICs) in which each function, or some combinations of certain of the functions, are implemented as custom logic. Of course, a combination of the two approaches can also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art will appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

All documents referenced herein are hereby incorporated by reference.

What is claimed is:

1. A method for sending targeted and contextual promotional offers to users, the method comprising the steps of:
receiving location information from one or more users for a particular venue by a storage/processing module;
gathering contextual information of each user of the one or more users, the contextual information being provided by each said user by a corresponding portable communication device;
mapping requirements of the merchant with said received location information and the gathered contextual information, the said step of mapping being performed based on a predefined criteria; and
sending one or more targeted promotional offers to a subset of said one or more users, the subset of one or more users being users whose requirements are mapped on said predefined criteria.

2. The method according to claim 1, each of the one or more users activating a permission session for tracking their location information.

3. The method according to claim 2 further comprising tracking the location information of the one or more users on a real-time basis after activation of the permission session.

4. The method according to claim 1, wherein said contextual information is gathered from one or more social networking services.

5. The method according to claim 1, wherein said contextual information is provided by the one or more users.

6. The method according to claim 5 further comprising requesting by said storage/processing module the contextual information from the one or more users.

7. The method according to claim 1, said predefined criteria being based on said contextual information and location information.

8. A method comprising the steps of:
receiving contextual data of a first user by a second user via a storage/processing module, the first user being associated with a first portable communication device and said second user being associated with a second portable communication device;
gathering location information of said first user by second user through said storage/processing module, said first user activating a permission session on his portable communication device;
purchasing a gift from a merchant by said second user for said first user based on a predefined criteria; and
informing said first user and said merchant confirming said purchase via said storage/processing module.

9. The method according to claim 8 further comprising tracking the location information of said first user on a real-time basis after activation of a permission session by the first user.

10. The method according to claim 8, wherein said first user deactivates a permission session either on receiving said promotional offers or on leaving a venue.

11. The method according to claim 8, wherein said contextual information is collected from one or more social networking services.

12. The method according to claim 8, wherein said contextual information is provided by said user.

13. The method according to claim 8, wherein the predefined criteria is based on at least one of the location information and the contextual information.

14. A system for sending targeted and contextual promotional offers on behalf of a merchant, said system comprising:
an information gathering module operative to
receive location information from at least one user at a particular venue, each of said at least one user acknowledging tracking the location at said particular venue, and a location tracking database storing the location information; and
collect contextual information of each said user, the contextual information being provided by each said user by a portable communication device, and a contextual information database storing the contextual information;
a mapping module to map the requirements of the merchant with said received location information and said contextual information, mapping being done based on predefined criteria; and
a transmitting module to send said promotional offers to a subset of at least one said user, the subset of at least one said user corresponding to users whose requirements are mapped on said predefined criteria.

15. The system according to claim 14, wherein said contextual information is collected from social networking services.

16. The system according to claim 14, wherein said contextual information is provided by said user.

17. The system according to claim 14, wherein said information gathering module requests the contextual information from said user.
